(19) United States
(12) Patent Application Publication
(10) Pub. No.: US 2025/0100062 A1
(43) Pub. Date: Mar. 27, 2025

(54) Position measurement for a welding gun

(71) Applicant: IVOSTUD GmbH, Breckerfeld (DE)

(72) Inventors: Philipp Schaefer, Hagen (DE); Robert Niemöller, Breckerfeld (DE)

(21) Appl. No.: 18/806,920

(22) Filed: Aug. 16, 2024

(30) Foreign Application Priority Data
Aug. 16, 2023 (DE) 10 2023 121 947.2

(51) Int. Cl. B23K 9/20; B23K 9/095

(52) U.S. Cl. CPC B23K 9/202; B23K 9/0953

(57) ABSTRACT

A device and a method for position measurement for welding guns, wherein based on the inductance of the coil, which changes depending on the insertion depth of the welding stud into a solenoid coil, it is inferred how far the welding stud is inserted into the solenoid in order to allow conclusions to be drawn concerning a proper arrangement of the welding stud relative to the workpiece.

### REFERENCE TO PENDING PRIOR PATENT APPLICATION

This patent application claims benefit of German Patent Application No. 10 2023 121 947.2, filed Aug. 16, 2023, which patent application is hereby incorporated herein by reference.

### FIELD OF THE INVENTION

The present invention relates to a device and a method for measuring the position of a welding element, in particular a welding stud, relative to a workpiece surface.

### BACKGROUND OF THE INVENTION

In arc welding, in particular stud welding, the stud to be welded to a workpiece during a regular process run is initially placed on the workpiece. To generate an arc between the workpiece and the stud, the stud is lifted from the workpiece, opposite an elastic force, by means of an electric solenoid while a high voltage is generated between these components. To initiate and carry out this movement, the solenoid includes an electric coil, which in the electrically energized state exerts a magnetic force on its coil core. The coil core, which is generally metallic, is connected to a stud holder that temporarily accommodates the welding stud, generally the welding element. The welding stud is thus lifted from the workpiece by magnetic force when current is applied to the coil. The arc generates a weld pool on the workpiece, into which the welding stud is subsequently lowered again, and at that location is welded to the workpiece. This process generally takes place fully automatically by means of a suitable controller, the individual method steps being coordinated with one another in a temporally optimized manner. The entire process run lasts only fractions of a second, for example less than 50 milliseconds. A further similar process run with a newly inserted welding stud may then follow.

In manual stud welding, the support tube of a welding gun is placed with its front open end on the workpiece, wherein the welding stud is centrally and longitudinally displaceably situated within the support tube, and before the welding process starts is pressed toward the workpiece by the elastic force.

For a high-quality weld joint, in manual stud welding it is particularly important that at the beginning, the welding stud is oriented orthogonally with respect to the workpiece surface, and its front end is at the same height as the front end of the support tube, namely, on the workpiece surface. This is the case when the support tube is actually oriented orthogonally with respect to the workpiece surface. In contrast, if the support tube is obliquely oriented, the welding stud protrudes from the support tube, and its position relative to the support tube and to the solenoid deviates from the ideal relative position, as clearly shown in FIG. 1. For an oblique support tube, the lift for the arc generation therefore increases, with an adverse effect on the quality of the weld pool, not to mention the stud, which then is not welded perpendicularly.

### SUMMARY OF THE INVENTION

The object of the invention is to provide a device and a method with which the perpendicular orientation of a welding gun during manual stud welding may be ensured, using simple means and without additional sensors.

The object is achieved by a method according to claim 1 and a device according to claim 10. Further advantageous embodiments result from the subclaims.

The invention proceeds from the finding that the inductance of the coil of the solenoid changes as a function of how far the coil core, coupled to the welding stud, is inserted into the coil. This is because the inductance increases the farther the coil core protrudes into the coil. Based on this insertion depth, it may be concluded whether the welding stud, for example at the start of the welding process, is placed correctly or obliquely on the workpiece. For an obliquely placed welding gun, the coil core does not protrude as far into the coil, so that its inductance is lower than for a perpendicularly placed welding gun. Thus, by determining the inductance at the start of the welding process, it may be determined how far the coil core is inserted into the coil, or whether the welding gun with its welding stud is placed perpendicularly on the workpiece.

In a very simple variant of the method according to the invention, it is therefore provided to determine by automatic control, at the start of a process run, a variable that represents the inductance of the coil, and to compare it to a predefined, settable setpoint value. This setpoint value may in particular also involve a value range within which a proper welding operation is to be expected. Therefore, in the following discussion, the term “setpoint value” is also intended to encompass a setpoint value range in the sense of a tolerance window. If the variable corresponds to the setpoint value or lies in the tolerance window defined by the setpoint value, the welding may then take place. In the simplest case, the method therefore comprises the following method steps:
(b) determining a variable that represents the inductance of the coil,
(c) automatically controlling the welding operation based on a comparison of the variable that represents the inductance of the coil to a predefined setpoint value.

If the determined variable is outside the setpoint value range, this could mean that the inductance of the coil is lower than would be expected for a correctly inserted welding stud; the coil core with the welding stud situated therein protrudes too far from the coil, for example because the support tube has been placed obliquely on the workpiece.

In this case, according to the invention the automatic control may terminate the otherwise normal process sequence. One option in this regard would be for the coil to not, or no longer, be acted on with a voltage that is sufficient to lift the stud from the workpiece, and/or for no arc to be generated. Alternatively or additionally, an optical or acoustic display generated by the controller could indicate the improperly placed welding gun.

The method according to the invention is also characterized in that the determination of the coil inductance takes place within the method even before the welding stud is significantly moved or an arc is even provided, i.e., within a few milliseconds at the start of the method. If the method is to be terminated due to an unsuitable inductance value, a lift-off of the stud or the generation of an arc will not take place at all.

A process run may preferably be initiated by placing the welding gun with its support tube on a workpiece as customary, and subsequently actuating an activating lever at the welding gun. Such welding guns are well known from the prior art. Actuating the activating lever triggers an automatic control which generally applies a voltage to the coil in order to lift the stud from the workpiece, opposite an elastic force, and controls the generation of the arc as well as the subsequent lowering of the stud into the weld pool. The method according to the invention may be easily integrated into the use of a conventional welding gun by initially automatically determining, upon actuation of the activating lever, a variable that represents the inductance of the coil. By making the comparison to the setpoint value according to the invention beforehand, a decision may then be automatically made as to whether the customary process sequence should follow, or be prematurely terminated.

A further process run could directly follow (within a few seconds) the preceding (successful or terminated) welding operation by reactuating the activating lever, after possibly correcting the orientation of the welding gun relative to the workpiece. If the newly determined variable for the inductance this time corresponds to the predefined setpoint value (because the welding stud, due to a correct orientation of the welding gun, protrudes farther into the coil and its inductance is thus sufficiently high), the controller may trigger the further regular process sequence for welding the stud, lift off the stud, form the arc, and carry out and end the welding operation as normal.

According to one advantageous embodiment of the invention, an additional method step is provided before the variable that represents the inductance of the coil is determined. Method step a) is provided for this purpose:
(a) applying a voltage (U) to the coil (S) at a starting point in time (t₀) and measuring the current (I(t)) flowing through the coil as a function of time (t).

This method step is provided to determine the variable that represents the inductance of the coil, using the voltage that is present at the coil and the current flowing through the coil, as well as the electric coil resistance.

According to the invention, this method step may be integrated into the regular operation of a conventional welding gun, since when the activating lever is actuated, the controller applies a voltage to the coil anyway to generate the necessary current for lifting the welding stud from the workpiece. With the voltage and the time-dependent current I(t) and the electric coil resistance R, physical variables are provided for determining a value that represents the inductance of the coil. The voltage could be assumed to be constant. However, it is preferably measured as a function of time in order to use a present voltage value in each case and to allow compensation for fluctuations.

According to one advantageous embodiment of the method, a time-dependent value F(t) is determined as the variable that represents the inductance of the coil, and is processed in a different way for the subsequent comparison to the setpoint value.

According to a first variant of the method, a first value F(t1) is determined at a first point in time t1. This first value may be compared to an appropriately predefined setpoint value that is desired at the point in time t1 in question to allow a proper welding operation to be carried out. In addition, multiple measured values may be determined at different points in time and compared to respective associated setpoint values. The comparison here in each case involves only a value F(t) and the associated setpoint value.

However, the curve of the variable F(t) that represents the inductance of the coil is preferably examined to allow it to be compared to a corresponding setpoint value. For this purpose, multiple measured values F(t) are detected at different points in time t1, t2, t3 . . . . A difference quotient D may be determined from at least two such measured values according to the following formula:

$$D = ( \frac{F ( {t}_{2} ) - F ( {t}_{1} )}{{t}_{2} - {t}_{1}} )$$

This difference quotient corresponds to a slope of the curve F(t) in the interval (t₂−t₁).

It is further preferred that, instead of a simple difference quotient, the slope D_{F} of a regression line may be determined which is formed based on a fairly large number of values for F(t) and the respective associated point in time t. Both the difference quotient D and the slope D_{F} of the regression line are variables that represent the inductance of the coil, which according to the invention may be used to control the further method by comparison to suitably predefined setpoint values.

The formation of the difference quotient D or the slope D_{F} takes into account the fact that the coil current is not constant or linear immediately after the voltage is applied, and different currents I(t) correspondingly occur for different points in time. This is discussed in greater detail below:

After a voltage U is applied at a starting point in time t₀ to a coil having the electrical resistance R, the coil current I(t) increases with time t due to the inductance L of the coil, in a delayed manner:

$$I ( t ) = \frac{U ( t )}{R} \cdot ( 1 - {e}^{- t \cdot \frac{R}{L}} ) \qquad ( 1 )$$

A direct, unique value for the inductance L cannot be derived therefrom due to the time-dependent current I(t). However, a function F(t) that changes linearly with time may be derived from equation (1).

According to one preferred embodiment of the method, it is therefore provided to form the time-dependent value F(t) from the transposed formula (1):

$$\begin{matrix}F ( t ) := Ln ( \frac{U ( t )}{U ( t ) - I ( t ) \cdot R} ) \cdot \frac{1}{R} \\ = t \cdot \frac{1}{L}\end{matrix} \qquad ( 2 )$$

Ln denotes the natural logarithm. The variables U(t) or I(t) may be easily specified or measured by means of the control unit that is used anyway for operating a conventional welding gun, since in addition to the suitability of the controller for measuring the voltage U(t), a device for measuring current is generally installed for short circuit monitoring. Due to the curve of F(t) that is linear with time, forming a difference quotient or a regression line slope D_{F} is sufficient to allow a statement to be made concerning the inductance L of the coil, and thus the proper position of the welding stud relative to the coil.

The difference quotient D or the slope D_{F} is preferably formed over two or more points in time t1, t2, t3 . . . which all lie within a predefinable measuring period T_{M}, beginning with the starting point in time t₀. This measuring period is advantageously selected in such a way that, although the voltage U is already present at the coil, the welding stud is not yet lifted from the workpiece because, for example, the coil current I(t) is not yet sufficient or the mass inertia of the stud has not yet been overcome. In any case, the measuring period T_{M} is selected in such a way that the welding stud does not yet carry out any appreciable movement relative to the welding gun or to the protective tube, since according to the invention this measuring period is used predominantly or solely to make a statement, early in the method, about the inductance of the coil.

In one exemplary embodiment, the measuring period T_{M} is no greater than 10 milliseconds, or for example is no greater than 5 milliseconds, beginning at the point in time t₀ at which the voltage U is applied to the coil. The particular suitable measuring period T_{M} is a function of various operating parameters or of the welding gun used, and may also be shorter or longer than in the stated examples, depending on the application.

The variable R (electrical resistance of the coil), which is also unknown, is likewise a function of various parameters, and cannot be assumed to be constant for a series of consecutive welding operations or process runs, since, for example, the coil heats up as the result of multiple process runs and its resistance is thus changed. However, it follows from formula (1) that, starting from a certain waiting period T_{R}>>t₀, which for conventional welding guns may be 10 milliseconds or more, for example, the inductance L becomes less important and the current I(t) assumes an essentially constant value I, so that the above formula (1) is reduced to:

$$R = \frac{U}{I} \qquad ( 3 )$$

The present coil resistance R may thus be calculated by use of the variables U and I, which are detected after 10 milliseconds, for example. Since at this point in time the measuring period T_{M} has preferably already elapsed, the present coil resistance R cannot be used in the present process run to determine the time-dependent value F(t) or a difference quotient. However, since the coil resistance R does not change appreciably within two short consecutive process runs, for determining the value F(t) according to equation (2) in a present process run Vᵢ, according to a further advantageous embodiment of the invention it is possible to use the electrical resistance value R which in a preceding, preferably directly preceding, process run Vᵢ₋₁ has been determined according to equation (3) after the waiting period T_{R} has elapsed, or may be determined from the values for the voltage U and the current I that are then detected.

For this purpose, during or after the end of the preceding process run Vᵢ₋₁ the values U and I and/or the variable R formed therefrom according to equation (3) may be stored in a memory unit of the controller, for example, and read out there in a subsequent process run, in particular the next immediately following process run Vᵢ, and used to calculate the value F(t). With each new, complete process run, the value for the coil resistance R is continuously updated and provided for the particular subsequent process run. This embodiment takes into account the fact that the coil resistance may change as a function of the welding process, the operating period, various operating parameters, and environmental parameters. By taking into account the nonconstant coil resistance via measurement or computation, the determination of the variable that represents the inductance of the coil may be significantly improved, and therefore the decision to terminate or continue a process run may be made even more reliably and accurately.

The determination of one or more of the variables that represent the inductance of the coil preferably takes place at points in time t1, t2, t3 . . . within the predefinable measuring period T_{M}, which begins to run at the point in time t=0 at which the voltage U is applied to the coil. The likewise predefinable waiting period T_{R}, likewise beginning at point in time t=0, is at least as long as the measuring period T_{M}. After the waiting period T_{R} elapses, the influence of the induction on the coil current has largely died down, so that, based on the coil current I then flowing and the associated voltage U, the present electrical resistance of the coil may be calculated with sufficient accuracy to allow its value to be used, in particular for a subsequent further process run.

One embodiment of the method according to the invention takes into account several of the aspects described above, and contains the following automatic method steps in a process run Vᵢ:
(a) applying a voltage (U(t) to the coil S beginning at a starting point in time t₀ and measuring the current flowing through the coil I(t) as a function of time t;
   This step may be triggered, for example, by actuating an activating lever at a welding gun, as a result of which an associated controller applies the voltage U(t) to the coil and detects the current flowing through the coil as a function of time.
(b) determining a time-dependent value F(t) that represents the inductance L of the coil S, according to the formula

$$F ( t ) := Ln ( \frac{U ( t )}{U ( t ) - I ( t ) \cdot R} ) \cdot \frac{1}{R} [ \frac{1}{kohm} ]$$

As explained above, this value may also be determined at multiple various points in time and used to form a difference quotient D or a regression line slope D_{F},
b₁) wherein these multiple various points in time are all to lie within a predefinable measuring period T_{M}, beginning at the starting point in time t₀,
and
b₂) wherein the value which, in a process run Vᵢ₋₁ that precedes, preferably immediately precedes, the process run Vᵢ, results from the values for the voltage U(t) and the current I(t) that are detected therein, after a predefinable waiting period T_{R} elapses, beginning at the starting point in time t₀, is used as the electrical resistance value R according to the formula

$$R = \frac{U ( t )}{I ( t )}$$

This method step may take place, for example, using a processor which is controlled by the controller, and which by specifying or determining the individual points in time t1, t2, t3 . . . incorporates the particular valid values for the voltage U, the current I, and the coil resistance R into the calculation of the value F(t) or R. The coil current I(t), which is time-dependent at least within the measuring period T_{M}, may be detected, for example, via a current measuring device that is provided even for conventional welding gun controllers, and transmitted to the processor for processing. The electric coil resistance R that is valid in a preceding process run, and that is to be used to calculate F(t) in the present process run, may be read out from a memory unit, for example, in which it has been stored during or after conclusion of the earlier process run.

This method step is preferably concluded within a few milliseconds after applying the voltage.
(c) comparing the value F(t) or the difference quotient D or slope D_{F} to an appropriate predefinable setpoint value (W_{a-b}).

This comparison takes place by means of the controller, preferably likewise using the above-mentioned processor. The comparison may be carried out with appropriate predefined setpoint values, for example, in such a way that exceeding or falling below a certain tolerance window, using the setpoint value, results in termination, but a value within the tolerance window results in continuation of the welding process.
(d) continuing the welding method with electromagnetic lifting of the welding stud from the workpiece (K) and generating an arc, or ending the welding method without generating an arc, based on the comparison.

Depending on the result of the comparison, an acoustically or visually perceivable signal may preferably be output to indicate to the operator the (im)properly oriented welding gun.

The physical variables that are predefined, measured, or otherwise determined during the method, which may include, for example, the coil voltage U(t), the coil current I(t), the coil resistance R, and the time-dependent value F(t) as well as further variables such as the difference quotient D or the slope D_{F}, may be stored in a memory unit which preferably can be controlled or read out by the controller. Of course, depending on the welding process, material pairing, and other boundary conditions, different physical variables as well as setpoint values W, waiting periods T_{R}, or measuring periods T_{M} may be predefined which may, for example, be stored in a memory unit that is accessible to the controller and retrieved, depending on the method. Setpoint values that are to define a setpoint value range or a tolerance window could possibly be predefined automatically or by the user or stored in the controller. One or more setpoint values may also be established using a first properly running welding process, wherein a determined value for F(t), D, D_{F} is used as a reference value for one, multiple, or all subsequent welding processes. By use of a predefinable tolerance range, a setpoint value range may be formed around the reference value thus detected, within which the values that are newly determined in each case in the subsequent welding process must lie in order to not prematurely terminate the welding method.

Some or all data are preferably transferable via a suitable interface to an output unit (monitor, printer, etc.) or a higher-level control unit, for example via a local or global, wired or wireless network. The interface may have a bidirectional design for receiving data and being able to store, for example, reference values for F(t), D, D_{F}, tolerance values for a setpoint value, a measuring period T_{M}, or a waiting period T_{R}, in the controller. For this purpose, an input unit may be connected to the network or to the controller. It is also conceivable to adapt the above-mentioned physical variables for the purpose of further processing, computation, representation, or transmission, using correction factors or correction methods that are determined empirically or in some other way, which for the sake of simplification was not done in the present description.

A device for carrying out the method according to the invention includes in particular
a welding gun with a support tube and a welding element, in particular a welding stud, that is held within the support tube by spring tension,
a solenoid that is formed with an electric coil, wherein a coil core that is coupled to the welding element protrudes at least partially into the coil interior, and
a controller that preferably includes a processor and that is designed to act on the coil with a voltage U at a starting point in time t₀ in order to generate a coil current I(t) and an electromagnetic force that acts on the welding stud, opposite the elastic force,
   wherein the controller is designed to measure the coil current I(t) and determine therefrom
the electrical resistance of the coil and
a variable that represents the inductance of the coil, in particular a previously described time-dependent value F(t) or a difference quotient or a slope D_{F},
   in order to continue or terminate the welding method as a function of the value thus determined.

Controllers for welding guns that do not have the above-described design for determining the coil resistance R and the inductance variable are well known in practice. The refinement of the controller according to the invention is preferably implementable in these known welding guns without an additional sensor system; it is necessary only to determine a variable that represents the inductance of the coil, on the basis of which the correct orientation of the welding gun or of the welding stud may be concluded by comparison to a setpoint value. For example, the coil current I, which is often measured anyway in conventional welding guns, may be used for this purpose.

The method described above is not limited to stud welding processes with a support tube. Rather, the approach according to the invention is in principle suited for welding processes in which the position or location of the element to be welded (welding stud, lug, or some other element) relative to the welding device or to the workpiece is to be monitored before or during the welding operation. This typically involves welding processes in which the element to be welded is automatically supplied to the welding device. In addition, a welding head that is guided by a robot may utilize the method according to the invention, for example to check whether, or how far, the loading pin that advances the welding element has entered, for example to allow the overhang of a welding stud relative to the welding head to be determined.

### BRIEF DESCRIPTION OF THE DRAWINGS

Several aspects of the method according to the invention are explained in greater detail below based on examples in the figures, which show the following:

FIG. 1 shows a simplified illustration of the problem underlying the invention,

FIG. 2 shows several components for carrying out the method according to the invention, and

FIG. 3 shows a diagram for illustrating the time-dependent value F(t).

### DETAILED DESCRIPTION OF THE PREFERRED EMBODIMENTS

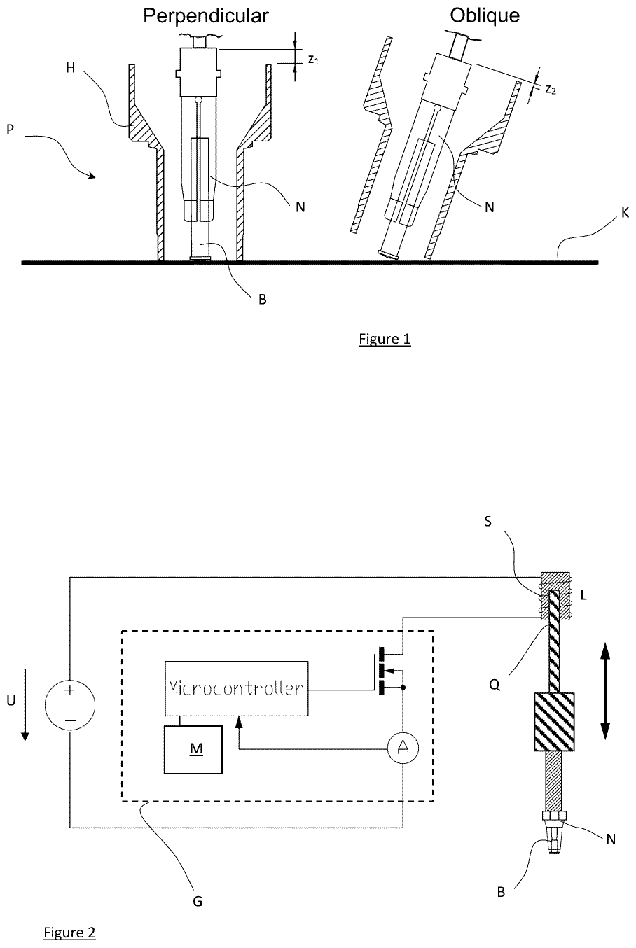

FIG. 1 shows a simplified schematic illustration of the problem underlying the invention. A welding gun, illustrated only in part, includes a support tube H, which at the start of a welding operation is to be placed with its lower open end on a surface of a workpiece K. A welding stud B that is to be welded to the workpiece K is guided centrally within the support tube. The welding stud B is initially held by a stud holder N. A coil core Q coupled to the stud holder N protrudes into an electric coil S, not illustrated in FIG. 1, that is part of the welding gun, and that is preferably immovably mounted relative to the support tube H. A magnetic force is exerted on the coil core Q, and thus on the stud holder N, by applying a coil voltage U(t) to the coil S, which causes the stud holder together with its welding stud B to lift from the workpiece K, opposite the force of a spring, not shown. An arc is generated between the lower tip of the welding stud B and the workpiece K which melts the workpiece K and/or the welding stud B, thus forming a weld pool. The welding stud B may subsequently be lowered in the direction of the workpiece K, i.e., into the weld pool, for example by switching off the coil voltage U(t) by means of the elastic force, so that after cooling, a solid weld joint is formed between the welding stud B, which is then detached from the stud holder N, and the workpiece K.

A support tube H that is correctly (orthogonally) placed on the workpiece at the start of the welding operation is illustrated in the left part of FIG. 1, the welding stud B with its lower tip lying in the plane that delimits the support tube with respect to the workpiece K or that is formed by the surface of the workpiece K. In this case, the coil core Q that is coupled to the welding stud B protrudes into the coil S by an amount z₁. The subsequent automatic lift of the stud B from the workpiece K may then take place at a predefined height as intended, with formation of the arc or weld pool that is also a function of the height, and welds the stud perpendicularly to the workpiece K.

In contrast, the case of a support tube H that is obliquely placed on the surface of the workpiece K is illustrated in the right part of FIG. 1. In this case, the welding stud protrudes beyond the front delimiting plane of the support tube H, as a result of which the coil core Q protrudes into the coil by a smaller amount z₂. After the coil voltage is applied, the lift of the welding stud B is undefined or too great, so that the correct formation of the arc is impaired, and the welding stud B, if a suitable weld pool is even formed at all, is obliquely welded to the workpiece K. Such a low-quality weld result should be prevented.

FIG. 2 shows a simplified illustration of several components of a device for carrying out a welding method according to the invention. The device includes a stud holder N with a welding stud B temporarily inserted therein, wherein a coil core Q coupled to the stud holder N protrudes into an electric coil S, analogously to the example according to FIG. 1. The inductance of the coil S changes as a function of how far the coil core Q is inserted into the coil S. With reference to the example from FIG. 1, it is apparent that, based on the insertion depth of the coil core Q in the coil S, a statement may be made concerning the particular inductance L of the coil S.

For this purpose, a controller G is provided which is designed to apply a predefinable coil voltage U to the coil S in a process run Vᵢ at a starting point in time t₀, for example by means of a transistor or field effect transistor, not denoted in greater detail. The controller preferably includes a microcontroller for data processing. In addition, the controller G is designed to measure the coil current I(t) as a function of time t. The controller G advantageously also includes an electronic memory M for storing or reading out data. These data may include various predefined or measured physical variables, in particular the coil voltage U(t), the coil current I(t), the electric coil resistance R, predefined or determined reference values, etc.

Furthermore, according to the invention the controller G is designed to determine a variable that represents the inductance L of the coil S, based on the physical variables that are measured during a process run or predefined. By comparing the value that represents the inductance L of the coil to a predefined reference value or setpoint value range W_{a-b}, it may be established whether the coil core at the start of the welding process is inserted far enough into the coil, i.e., the welding stud has been positioned perpendicularly with respect to the workpiece surface. On this basis the controller G may automatically control the further course of the welding operation, in particular disconnecting the coil S from the coil voltage U if a value that represents the inductance L of the coil is outside a setpoint value range, so that a welding gun that is placed obliquely on the workpiece may be assumed.

The controller illustrated in FIG. 2 is designed to form a time-dependent value F(t) that represents the inductance L of the coil according to formula (2) in the above description. This value may preferably be formed at at least two different points in time t₁ and t₂ in order to form therefrom a gradient D of the time-dependent value F(t), which for further method control within the controller may be compared to a setpoint value range W_{a-b}. The two points in time t₁ and t₂ lie within a predefinable measuring period T_{M} of less than 5 milliseconds, beginning at the starting point in time t₀.

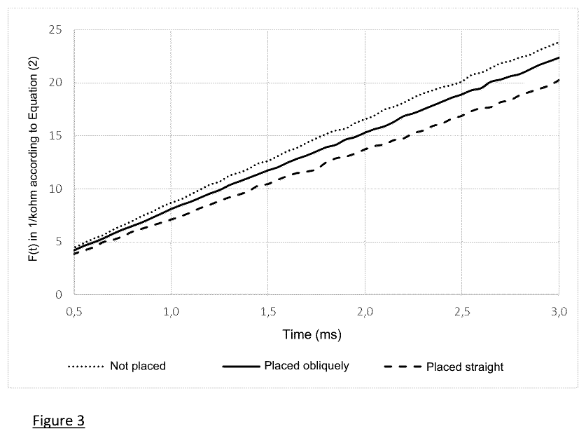

FIG. 3 shows an example of the curve of a time-dependent value F(t) that represents the inductance of the coil S as a function of time t for three different cases, beginning at 0.5 milliseconds after the application of the coil voltage U at point in time t₀, up to the elapse at approximately 3 milliseconds. All three curves show an essentially linear profile. The uppermost, dotted-line curve represents the case of a welding gun that is not placed on the workpiece at all. In this case, as is readily inferable from the example in FIG. 1, the coil core Q protrudes even farther from the support tube H than shown in the right portion of FIG. 1. The inductance L of the coil S is correspondingly (too) low or the slope of the associated dotted-line curve is correspondingly large, for example approximately 7.0 kohm·ms⁻¹. In the curve for the value F(t), an obliquely placed welding gun according to the example of the middle curve in FIG. 3 results in a slope D_{F} of approximately 6.5 kohm·ms⁻¹, for example. The welding process is to be carried out only for a correctly placed welding gun, for which a curve F(t) according to the lowermost, dashed-line curve having a slope D_{F} of 6.0 kohm·ms⁻¹, for example, results. For this purpose, a setpoint value W of 6.1 kohm·ms⁻¹ obtained from empirical determinations, for example, could have been stored in the controller, so that after the curve of F(t) is determined, the controller G then continues the welding process with stud lift-off and arc generation only when the measured value within a tolerance window, determined by the setpoint value, has this desired slope.

Of course, depending on the welding process and the boundary conditions to be considered (coil voltage, coil type, desired stud lift-off, etc.), different setpoint values may be specified, and depending on the process, for example stored in the memory M, ready for retrieval.

Lastly, the controller G according to FIG. 3 is also designed to determine the electric coil resistance R according to the equation R=U/I in order to take this coil resistance into account in calculating the time-dependent value F(t). In a process run Vᵢ for calculating F(t), the value of the coil resistance R that results from the values of the coil voltage U(t) and the coil current I(t) in the directly preceding process run Vᵢ₋₁ is preferably used. The value of the coil current I(t) that was measured by the controller G after a predefinable waiting period T_{R} elapses, beginning at the starting point in time t₀, is advantageously used. The waiting period is preferably greater than 10 milliseconds, most preferably greater than 30 milliseconds, since after such a waiting period elapses, the inductance L of the coil no longer has an appreciable influence on the coil current, and a sufficiently reliable value for the coil resistance may thus be determined.

### LIST OR REFERENCE NUMERALS

B welding element, welding stud
D difference quotient
D_{F} slope of a regression line
F, F(t) variable that represents the inductance L of the coil S
G controller
H support tube
I, I(t) current through the coil S
K workpiece
L inductance of the coil S
M memory
N stud holder
P welding gun
Q coil core
R electrical resistance of the coil S
S coil
t time
t₀ starting point in time
t₁, t₂ predefinable points in time
T_{M} predefinable measuring period
T_{R} predefinable waiting period
U, U(t) voltage present at the coil S
Vᵢ ith process run
Vᵢ₋₁ process run directly preceding the ith process run
W setpoint value
z₁, z₂ insertion depth

1. A welding method that is designed to lift a welding element, in particular a welding stud (B), by an amount from a workpiece (K) at the start of a welding operation by means of an electromagnetic coil (S) in order to generate an arc between the welding element (B) and the workpiece (K), wherein the method may be carried out in multiple consecutive process runs (V₁, V₂ . . . ), and in a process run (V₁, V₂ . . . Vᵢ, . . . ) comprises at least the following method steps:
(b) determining a variable (F, D, D_{F}) that represents the inductance (L) of the coil (S),
(c) automatically controlling the welding operation based on a comparison of the variable (F, D, D_{F}) that represents the inductance (L) of the coil (S) to a predefined setpoint value (W).

2. The method according to claim 1, characterized in that prior to method step (b) the following method step is carried out:
(a) applying a voltage (U(t)) to the coil (S) at a starting point in time (to) and measuring the current (I(t)) flowing through the coil as a function of time (t),
wherein the variable (F, D, D_{F}) that represents the inductance (L) of the coil (S) is formed in method step (b) using at least the voltage (U(t)), the current (I(t)), and an electric coil resistance (R).

3. The method according to claim 2, characterized in that as the variable (F, D, D_{F}) that represents the inductance (L) of the coil (S) in method step (b) of claim 1, at least one time-dependent value (F(t)) is determined at at least one first point in time (t1) as a first value (F(t1)), wherein
a) the first value (F(t1)) is compared to a predefined setpoint value (W) that is associated with this first value,
or
b) in addition to the first value (F(t1)), for each of the various further points in time (t2, t3, t4 . . . ) at least one further associated value (F(t2), F(t3), F(t4) . . . ) is determined, and either a difference quotient
$$D = ( \frac{F ( {t}_{2} ) - F ( {t}_{1} )}{{t}_{2} - {t}_{1}} )$$
is determined, based on two of these values (F(t2), F (t3), F(t4) . . . ), or the slope (D_{F}) of a regression line for the curve of F(t) is determined, based on more than two values (F(t1), F(t2), F(t3) . . . ) and the associated points in time (t1, t2, t3 . . . ), and the difference quotient (D) or the slope (D_{F}) or a comparative value derived therefrom is compared to a setpoint value (W) that is predefined in this regard,
wherein based on the comparison, measures for further carrying out the method are derived.

4. The method according to claim 3, characterized in that the time-dependent value ((F(t)) is determined based on the formula
$$F ( t ) := Ln ( \frac{U ( t )}{U ( t ) - I ( t ) \cdot R} ) \cdot \frac{1}{R}$$

5. The method according to claim 2, characterized in that for a process run (Vᵢ), the electric coil resistance (R) is determined according to the formula
$$R = U ( t ) / I ( t ) ,$$
wherein the values from a preceding, preferably immediately preceding, process run (Vᵢ₋₁) are used for the voltage (U(t)) and the current ((I(t)).

6. The method according to claim 5, characterized in that the values of the voltage (U(t)) or of the current (I(t)) that are predefined or measured after a predefinable waiting period (T_{R}) elapses, beginning at the starting point in time (t₀), are used for calculating the electric coil resistance (R).

7. The method according to claim 1, comprising the following automatic method steps in a process run (Vᵢ):
(a) applying a voltage (U(t)) to the coil (S) beginning at a starting point in time (t₀) and measuring the current (I(t)) flowing through the coil as a function of time (t);
(b) determining a time-dependent value ((F(t)) that represents the inductance (L) of the coil (S), based on the formula
$$F ( t ) := Ln ( \frac{U}{U - I ( t ) \cdot R} ) \cdot \frac{1}{R}$$
at at least two various points in time (t1, t2, t3 . . . ) and forming the difference quotient (D)
$$D = ( \frac{F ( {t}_{2} ) - F ( {t}_{1} )}{{t}_{2} - {t}_{1}} )$$
or forming the slope (D_{F}) of a regression line that is formed using multiple values (F(t1), F(t2), F(t3) . . . ),
b₁) wherein the points in time (t1, t2, t3 . . . ) used to form the difference quotient (D) or the slope (D_{F}) each lie within a predefinable measuring period (T_{M}), beginning at the starting point in time (t₀),
and
b₂) wherein the value which, in a process run (Vᵢ₋₁) that precedes, preferably immediately precedes, the process run (Vᵢ), results from the values for the voltage U(t) and the current I(t) that are detected therein after a predefinable waiting period (T_{R}) elapses, beginning at the starting point in time (t₀), is used as the electrical resistance value (R) according to the formula
$$R = \frac{U ( t )}{I ( t )}$$
(c) comparing the difference quotient (D) or the slope (D_{F}) or a comparative value derived therefrom to a predefinable setpoint value (W);
(d) continuing the welding method with electromagnetic lifting of the welding stud from the workpiece (K) and generating an arc, or ending the welding method without generating an arc, based on the comparison result.

8. The method according to claim 7, wherein the following apply:
waiting period (T_{R})>10 ms,
and/or
measuring period (T_{M})<5 ms.

9. The method according to claim 1, characterized in that a measure for the insertion depth of a coil core (Q), coupled to the welding element, in the coil (S) is derived from the variable (F) that represents the inductance (L) of the coil (S) in order to store this measure or a value formed with same and/or display it to the operator and/or compare it to a setpoint value (W) for further method control.

10. A device for carrying out a welding method according to one of the preceding method claims, comprising
a welding gun (P) with a support tube (H) and a welding element (B) that is held within the support tube (H) by spring tension,
an electric coil (S) with a coil core (Q) that is movable therein and coupleable to the welding element (B),
a controller (G) that is designed to act on the coil with a voltage (U) at a starting point in time (to) in order to generate a coil current (I(t)) and an electromagnetic force that acts on the welding stud (B) by use of the coil core (Q),
characterized in that
the controller (G) is designed to measure the coil current (I(t)) and determine therefrom
the electrical resistance (R) of the coil (S) and
a variable (F) that represents the inductance (L) of the coil (S), in particular a time-dependent value F(t) or a difference quotient (D) or a slope (D_{F}) defined according to claim 3
in order to continue or terminate the welding method as a function of the value (F(t), D, D_{F}) thus determined.

11. The device according to claim 10, wherein the controller (G) is designed to determine
the electrical resistance (R) after a predefinable waiting period (T_{R}) elapses, beginning at the starting point in time (t₀)
and/or
the time-dependent value (F(t)) or a difference quotient (D) or a slope (D_{F}) therefrom before a predefinable measuring period (T_{M}) elapses, beginning at the starting point in time (t₀),
wherein the following preferably are to apply:
10 ms<waiting period (t_{R})<30 ms,
and/or
starting point in time (t₀)<measuring period (t_{L})<5 ms.
